(19) United States
(12) Patent Application Publication
(10) Pub. No.: US 2008/0172328 A1
(43) Pub. Date: Jul. 17, 2008

(54) METHOD AND SYSTEM FOR GENERATING ELECTRICITY

(76) Inventor: Amir Ajilian, Karaj (IR)

Correspondence Address: BARRY CHOOBIN, 193 SUITE #18, TALEGHANI, BAHARE SHOMALI, TEHRAN, 1563714311, omitted

(21) Appl. No.: 12/036,220

(22) Filed: Feb. 23, 2008

(51) Int. Cl. H02J 4/00; H02J 7/14; A63B 24/00; G06Q 20/00

(52) U.S. Cl. 705/39; 320/107; 482/2; 322/17

(57) ABSTRACT

The present invention discloses a method and system for converting sports movement into electrical energy and/or storing the generated electrical energy for later use and or injecting the generated electrical energy into nationwide and local electricity networks, comprising converting mechanical energy created by a human physical movement which is applied to sports equipment (1); employing gear boxes, gears, pulleys, chain, belt (2) to convert said mechanical energy; determining speed and power of said sports equipments; changing speed and power of said sports equipments; determining and/or changing direction of said power of said sports equipments; generating electricity of 1.5 to 360 volts and power of 1 watt-10 kilowatt AC or DC electricity by different types of dynamos (3), alternators, generators, and or any other means for generating electricity; measuring amount of said generated electricity; storing said generated electricity in a battery or in a capacitor; inverting said generated electricity stored into 220/110 volts; and controlling said generated electricity.

### BACKGROUND OF THE INVENTION

The present invention relates to an electric generator, and particularly to a generator for converting mechanical motion into electrical energy. Generating energy is one of the biggest needs of present-day man. Considering the fact that fossil fuels will run out in near future and considering the increasing problem of environment, providing clean and easily accessible energy is man's urgent demand. Furthermore, in consideration of the fact that throughout the world every day hundreds of people keep their physical fitness by doing some kind of exercises and this very big energy goes in waste. Therefore, it would be advantageous to convert physical movements into electricity by constructing “sports power plants”, which is capable to generate clean energy. The present invention will promote public health and saves millions of dollars a year in therapeutic costs. The present invention meets the daily need to physical education and, if necessary, will meet the financial needs of millions of people. This energy is a clean energy, environmentally sound and pollution free.

### SUMMARY OF THE INVENTION

The present invention discloses a method and system for converting sports movement into electrical energy and/or storing the generated electrical energy for later use and or injecting the generated electrical energy into nationwide and local electricity networks. According to preferred embodiment of the present invention, said method comprises steps of; converting mechanical energy created by a human physical movement which is applied to sports equipment (1); employing gear boxes, gears, pulleys, chain, belt (2) to convert said mechanical energy; determining speed and power of said sports equipments; changing speed and power of said sports equipments; determining and/or changing direction of said power of said sports equipments; generating electricity of 1.5 to 360 volts and power of 1 watt-10 kilowatt AC or DC electricity by different types of dynamos (3), alternators, generators, and or any other means for generating electricity; measuring amount of said generated electricity; storing said generated electricity in a battery or in a capacitor; inverting said generated electricity stored into 220/110 volts; and controlling said generated electricity.

In another embodiment of the present invention, disclosed, a method and system for converting mechanical energy created by a human physical movement which is applied to sports equipment (1); employing gear boxes, gears, pulleys, chain, belt (2) to convert said mechanical energy; determining speed and power of said sports equipments; changing speed and power of said sports equipments; determining and/or changing direction of said power of said sports equipments; generating electricity of 1.5 to 360 volts and power of 1 watt-10 kilowatt AC or DC electricity by different types of dynamos (3), alternators, generators, and or any other means for generating electricity;

measuring amount of said generated electricity; storing said generated electricity in a battery or in a capacitor or transferring said generated electricity directly to inverting unit (10); inverting said generated electricity stored into 220/110 volts; and controlling said generated electricity; changing said generated electricity according to characteristics of signals from a grid; and rectifying aid generated electricity.

In another embodiment of the present invention, disclosed, a method and system for converting mechanical energy created by a human physical movement which is applied to sports equipment (1); comprising steps above and further said method comprises steps of paying a predetermined amount of money or credit to operator of said sport equipment base don the amount of electricity produced by said operator.

Other objects, advantages and novel features of the present invention will become apparent from the following detailed description of the invention when considered in conjunction with the accompanying drawings.

### BRIEF DESCRIPTION OF THE DRAWINGS

FIG. 1 is a block diagram of the preferred embodiment of the present invention.

FIG. 2 is a block diagram of another embodiment of the present invention wherein the generated electricity is injected to electricity grid.

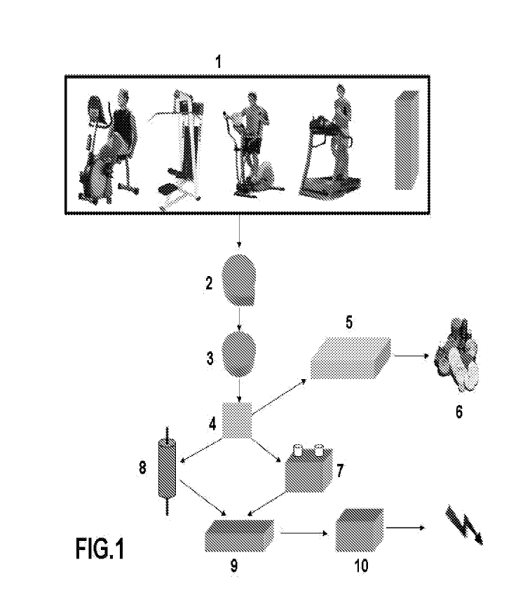

FIG. 1 is an illustration of constructing and or converting the sports clubs and centers into electricity generating units.

### DETAILED DESCRIPTION OF THE INVENTION

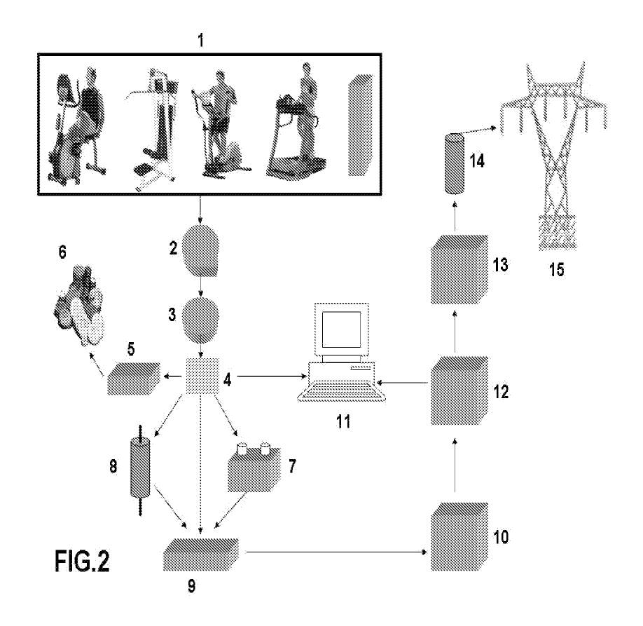

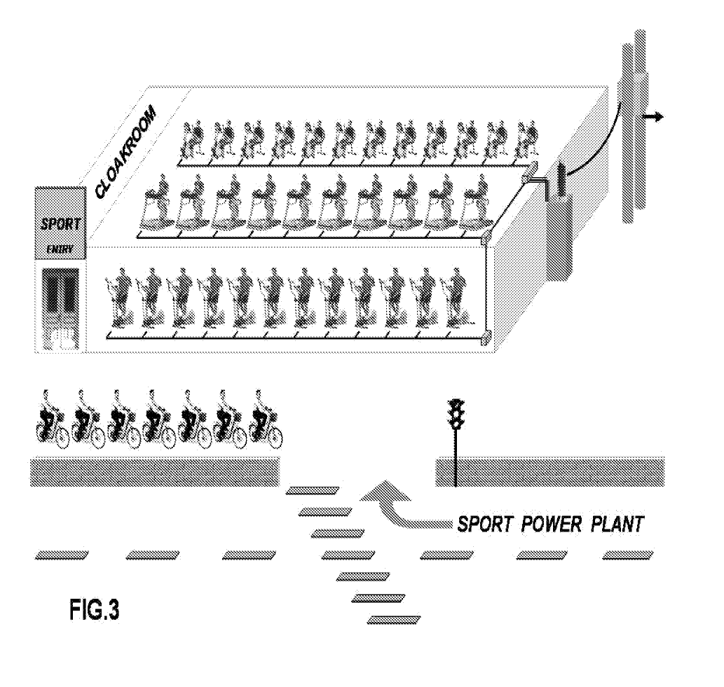

Referring initially to FIG. 1, the performance of the present invention is based on converting sports movement into electrical energy and, if needed, storing the generated electricity for public use and or injecting it into nationwide and local electricity networks. Based on this concept, the physical movements are converted by different sports equipments (1) through using different types of gear boxes, gears, pulleys, chain, belt, and means (2) for determining and changing the speed and power, and if necessary, the direction thereby converting them into electricity by different types of dynamos, alternators, generators, and or any other means for generating electricity of 1.5 to 360 volts and power of 1 watt-10 kilowatt AC or DC electricity (3). The generated electricity may be stored in different rechargeable batteries or capacitors and or any other means of electricity reservation (7, 8). The electricity may be directed into inverter (9) directly from production source or from the reserve and is converted into needed electricity (11). In case of storing and reserving, sport equipment may be used as emergent generator and UPS for being used in houses, working places, research centers and any other places. Thus, by doing sports exercises, electricity is generated and stored and then used later in any time and space which it may be needed. The electricity generated by one or more sports equipment (1) may be directed into a processing system (12) and transformers (13) and then inject into electricity network (15) after coming out of inverter (9). The processing system (12) is a perfect system for injecting the generated electricity into electricity grid and is able to register and keep all information. In all routes there are types of rectifiers and supporting switches. For each sports equipment (1), one indicating system consisting of ammeter, voltmeter, watt-hour meter (or kilowatt hour meter) and any other needed indicator (4) and information is transmitted to one or more computers (11). The above information is also transmitted to one automated teller machine (ATM) or automated machine for entering credit in form of a card (5), if necessary, the price of the generated electricity (6) may be paid to the generator or sportsperson in cash or by entering as a credit. Thus, sports power plants (FIG. 2) (FIG. 3) are constructed for all types of sports clubs, sports classes, sports centers of private and public sectors, sports places existing in schools, universities, and departments, military bases, and any other sports space are converted into power plant.

Referring back to FIG. 1, the physical movements are converted by different sports equipments and if necessary, changing the speed or direction by one or more types of gear boxes, gears, pulleys, chains, belts, shafts, ball bearings, and means for increasing or decreasing of speed and or changing the direction of movement. Then, the force generated by physical movement is converted into electricity by (3) one or more types of dynamos, alternators, generators or any means of producing AC or DC electricity of 1.5 to 360 volts and power of 1 watt-10 kilowatts and its quantity is determined through using (4) voltmeter and ammeter, kilowatt hour meter or watt-hour meter and any other type of needed measuring instruments. Then, the information of generated electricity is transferred to (5) automated teller machine or credit registration card and the price of the generated electricity is paid to the producer (6). The generated electricity is sent to (7) different types of rechargeable batteries with different capacities, or to (8) different capacitors or electricity reserving units for being reserved and then is converted into electricity needed for consumption by (9) inverter or passes from (10) electricity panel for controlling purposes and protection of final outlet (11) generated electricity.

FIG. 2 shows, the physical movements are converted by (1) sports equipments and if necessary, changing the speed or direction by (2) one or more types of gear boxes, gears, pulleys, chains, belts, shafts, ball bearings, and means for increasing or decreasing of speed and or changing the direction of movement. Then, it is converted into electricity by (3) one or more types of dynamos, alternators, generators or any means of producing AC or DC electricity of 1.5 to 360 volts and power of 1 watt-10 kilowatts and its quantity is determined through using (4) voltmeter and ammeter, kilowatt hour meter or watt-hour meter and any other type of needed measuring instruments. Then, the information of generated electricity is transferred to one or more types of computers (11) or laptop and for paying the price of generated electricity to an automated teller machine (5) or credit registration card and the price of the generated electricity is paid to the producer or producers (6). The generated electricity is sent to (7) different types of rechargeable batteries with different capacities, or to (8) different capacitors or electricity reserving units for being reserved and then is converted into needed electricity or is entered directly and without reservation to the unit (9) different invertors and is entered into for controlling purposes and protection of the unit (10). For strengthening and changing the voltage, amperage, frequency, and other agents (12) processor system and (13) different types of transformers needed for injecting electricity into network which shall be able to register all information. Finally, by passing (14) different rectifiers and emergency switches it becomes usable for the complex or entering into (15) electricity network.

FIG. 3 shows constructing and or converting the sports complexes to power plants for generating electricity for the complex and r selling to electricity network.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

We claim:

1. A method for generating electricity comprising steps of:
Converting mechanical energy created by a human physical movement which is applied to a sport equipment, wherein said converting further comprises;
Employing at least one means selected form a group comprising, at least one gearbox, at least one gear, at least one pulley, at least one chain, and at least one belt to convert said mechanical energy;
Determining speed and power of said sport equipment;
Changing speed and power of said sport equipments;
Determining and/or changing direction of said power of said sport equipment;
generating electricity of 1.5 to 360 volts and power of 1 watt-10 kilowatt AC or DC electricity;
Measuring amount of said generated electricity;
Storing said generated electricity in a battery or in a capacitor;
Inverting said stored generated electricity into 220/110 volts; and
Controlling said generated electricity.

2. A method as claimed in claim 1, wherein said method further comprises paying a predetermined amount of money or credit for said human physical movement, wherein said amount is based on the amount of electricity generated by said human physical movement.

3. A system for generating electricity wherein said system comprises: means for converting mechanical energy created by a human physical movement which is applied to a sport equipment;
Means for employing at least one means selected form a group comprising, at least one gear box, at least one gear, at least one pulley, at least one chain, and at least one belt to convert said mechanical energy;
Means for determining speed and power of said sport equipment;
Means for changing speed and power of said sport equipment;
Means for determining and/or changing direction of said power of said sport equipment;
Means for generating electricity of 1.5 to 360 volts and power of 1 watt-10 kilowatt AC or DC electricity;
Means for measuring amount of said generated electricity;
Means for storing said generated electricity in a battery or in a capacitor;
Means for inverting said stored generated electricity into 220/110 volts; and
Means for controlling said generated electricity.

4. A system as claimed in claim 3, wherein said system further comprises a means for paying a predetermined amount of money or credit for said human physical movement, wherein said amount is based on the amount of electricity generated by said human physical movement.

5. A method for generating electricity comprising steps of:
Converting mechanical energy created by a human physical movement which is applied to a sport equipment, wherein said converting further comprises;
Employing at least one means selected form a group comprising, at least one gearbox, at least one gear, at least one pulley, at least one chain, and at least one belt to convert said mechanical energy;
Determining speed and power of said sport equipment;
Changing speed and power of said sport equipment;
Determining and/or changing direction of said power of said sport equipment;
Generating electricity of 1.5 to 360 volts and power of 1 watt-10 kilowatt AC or DC;
Measuring amount of said generated electricity;
Storing said generated electricity in a battery or in a capacitor;
Transferring said generated electricity directly to inverting unit;
Inverting said generated electricity stored into 220/110 volts;
Controlling said generated electricity;
Changing said generated electricity according to characteristics of signals from a grid; and rectifying aid generated electricity.

6. A method as claimed in claim 5, wherein said method further comprises paying a predetermined amount of money or credit for said human physical movement, wherein said amount is based on the amount of electricity generated by said human physical movement.
